(19) United States
(12) Patent Application Publication
(10) Pub. No.: US 2024/0045039 A1
(43) Pub. Date: Feb. 8, 2024

(54) TIME-OF-FLIGHT DATA PROCESSING DEVICE BASED ON INTELLIGENCE PROCESSING UNIT AND DATA PROCESSING METHOD

(71) Applicant: SigmaStar Technology Ltd., Xiamen (CN)

(72) Inventor: Yu-Dong LI, Shanghai (CN)

(21) Appl. No.: 18/140,182

(22) Filed: Apr. 27, 2023

(30) Foreign Application Priority Data
Aug. 2, 2022 (CN) 202210923640.4

(51) Int. Cl. G01S 7/4915; G01S 17/32; G06T 7/55

(52) U.S. Cl. CPC G01S 7/4915; G01S 17/32; G06T 7/55; G06T 2207/10028; G06T 2207/20224

(57) ABSTRACT

A data processing method includes performing a conditional logical process and an image difference calculation by a vector calculating unit in an intelligence processing unit (IPU) according to sensing data generated by a time-of-flight ranging device to generate depth data, and performing a filter process by a multiply-accumulate calculation unit in the IPU according to the depth data to generate output data.

This application claims the benefit of China application Serial No. CN202210923640.4, filed on Aug. 2, 2022, the subject matter of which is incorporated herein by reference.

### BACKGROUND OF THE INVENTION

### Field of the Invention

The present application relates to a time-of-flight (ToF) ranging system, and more particularly, to a data processing device and a data processing method that process time-of-flight data by an intelligence processing unit (IPU) in the system.

### Description of the Related Art

Raw data provided by a time-of-flight ranging sensor needs to undergo calculations in order to be converted into valid distance of depth information. Thus, the calculation time affects subsequent processes and applications of the overall system. In the prior art, a universal processor is usually used to perform conversion of depth information, or a multi-thread processing structure is used to accelerate conversion of depth information. However, to withstand larger computation amounts, the conventional techniques above need to employ processors or processing structures with more powerful computation capabilities, resulting in increases in both overall power consumption and hardware costs.

### SUMMARY OF THE INVENTION

In some embodiments, it is an object of the present application to provide a time-of-flight data processing device that assists in processing time-of-flight data by using an intelligence processing unit (IPU), and a data processing method thereof, so as to improve the drawbacks of the prior art.

In some embodiments, the time-of-flight data processing device includes an IPU. The IPU performs the following operations on sensing data generated by a time-of-flight ranging device: performing a conditional logical process and an image difference calculation according to the sensing data to generate depth data, and performing a filter process according to the depth data to generate output data. The IPU includes a vector calculating unit and a multiply-accumulate (MAC) calculation unit. The conditional logical process is performed by the vector calculating unit, and the filter process is performed by the MAC calculation unit.

In some embodiments, the data processing method includes performing a conditional logical process and an image difference calculation by a vector calculating unit in an intelligence processing unit (IPU) according to sensing data generated by a time-of-flight ranging device to generate depth data, and performing a filter process by a multiply-accumulate calculation unit in the IPU according to the depth data to generate output data.

Features, implementations and effects of the present application are described in detail in preferred embodiments with the accompanying drawings below.

### BRIEF DESCRIPTION OF THE DRAWINGS

To better describe the technical solution of the embodiments of the present application, drawings involved in the description of the embodiments are introduced below. It is apparent that, the drawings in the description below represent merely some embodiments of the present application, and other drawings apart from these drawings may also be obtained by a person skilled in the art without involving inventive skills.

FIG. 1 is a schematic diagram of a ranging system according to some embodiments of the present application;

FIG. 2 is a flowchart of a calculation process of a time-of-flight algorithm executed by an intelligence processing unit (IPU) in collaboration with a central processing unit (CPU) according to some embodiments of the present application;

FIG. 3 is a schematic diagram of multiple sets of data in a memory in FIG. 1 and used to a perform phase conversion in FIG. 2 according to some embodiments of the present application;

FIG. 4A is a schematic diagram of multiple sets of data in a memory in FIG. 1 and used to perform a phase conversion in FIG. 2 according to some embodiments of the present application;

FIG. 4B is a schematic diagram of multiple sets of data in a memory in FIG. 1 and used to perform a depth conversion in FIG. 2 according to some embodiments of the present application;

FIG. 5 is a schematic diagram of multiple sets of data in a memory in FIG. 2 and used to perform a phase conversion and a non-linear function in a depth conversion in FIG. 2 according to some embodiments of the present application;

FIG. 6 is a schematic diagram of multiple sets of data in a memory in FIG. 2 and used to perform a filter process in FIG. 2 according to some embodiments of the present application; and

FIG. 7 is a flowchart of a data processing method according to some embodiments of the present application.

### DETAILED DESCRIPTION OF THE INVENTION

All terms used in the literature have commonly recognized meanings. Definitions of the terms in commonly used dictionaries and examples discussed in the disclosure of the present application are merely exemplary, and are not to be construed as limitations to the scope or the meanings of the present application. Similarly, the present application is not limited to the embodiments enumerated in the description of the application.

The term “coupled” or “connected” used in the literature refers to two or multiple elements being directly and physically or electrically in contact with each other, or indirectly and physically or electrically in contact with each other, and may also refer to two or more elements operating or acting with each other. As given in the literature, the term “circuit” may be a device connected by at least one transistor and/or at least one active element by a predetermined means so as to process signals.

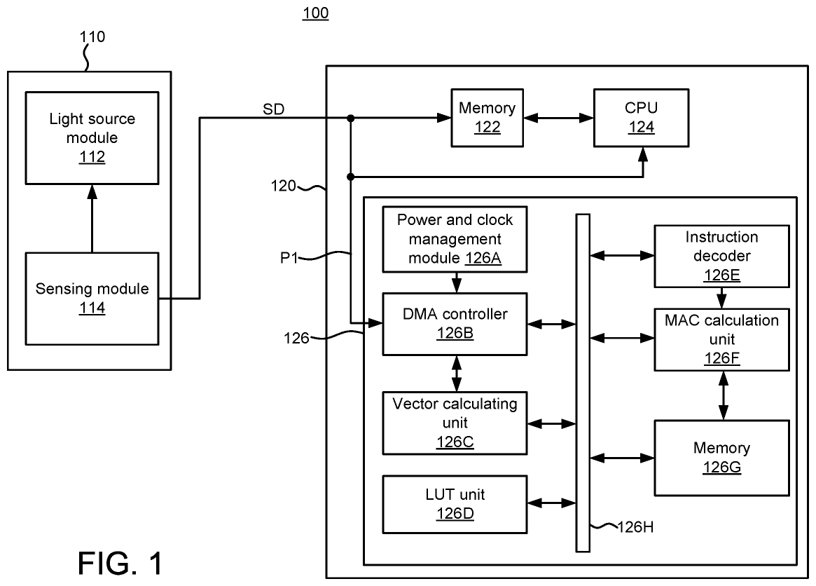

FIG. 1 shows a schematic diagram of a ranging system 100 according to some embodiments of the present application. In some embodiments, the ranging system 100 may obtain distance information of an object by using a time-of-flight (ToF) algorithm to thereby calculate depth information and/or profile information of the object.

The ranging system 10 includes a time-of-flight ranging device 110 and a time-of-flight data processing device 120. The time-of-flight ranging device 110 includes a light source module 112 and a sensing module 114. The light source module 112 may emit a light signal to an object according to the control of the sensing module 114. The sensing module 114 may sense the light signal reflected back from the object, perform subsequent operations such as signal processing and analog-to-digital conversion on the signal to generate sensing data SD, and transmit the sensing data SD to the time-of-flight data processing device 120 for subsequent operations.

In some embodiments, the sensing module 114 may include a clock generator (not shown) and a temperature sensing circuit. The clock generator may generate a clock signal needed for individual circuits, and the sensing module 114 may dynamically modulate a period of the light signal according to the clock signal generated by the clock generator and an operating temperature of a current environment sensed by the temperature sensing circuit. It should be noted that the configuration details of the time-of-flight ranging device 110 above are examples, and are not to be construed as limitation to the present application.

The time-of-flight data processing device 120 includes a memory 122, a central processing unit (CPU) 124 and an intelligence processing unit (IPU) 126. In some embodiments, the memory 122 may be, for example but not limited to, a dynamic random access memory (DRAM). The memory 122 is shared by the CPU 124 and the IPU 126. The IPU 126 may be a processor capable of executing a machine learning model and/or a neural network model. In some embodiments, the IPU 126 may perform a convolution operation on image data to analyze feature information in the image data. In some embodiments, the IPU 126 includes a power and clock management module 126A, a direct memory access (DMA) controller 126B, a vector data calculating unit 126C, a look-up table (LUT) unit 126D, an instruction decoder 126E, a multiply-accumulate (MAC) calculation unit 126F, a memory 126G and a bus 126H, wherein the above multiple modules and/units may be coupled to one another by the bus 126H for communications. The power and clock management module 126A may provide and set power and timings indicated by the clock signal for other modules and/or units.

Once the DMA controller 126B receives an instruction of the CPU 124, the DMA controller 126B may read from the memory 122 and store at least a part of the sensing data SD to the memory 126G. Once the instruction decoder 126E completes decoding the instruction to be executed, at least corresponding one of the vector data calculating unit 126C, the LUT unit 126D and/or the MAC calculation unit 126 may read corresponding data from the memory 126G for operations. Once all the operations are completed, the DMA controller 126B stores an operation result back to the memory 122, as output data. In some embodiments, the output data may be, for example but not limited to, depth information of an object under detection. In some embodiments, the memory 126G may be, for example but not limited to, a static random access memory (SRAM).

In some related art, a universal processor is used to calculate raw data generate by a time-of-flight ranging sensor. The raw data needs to undergo certain operations in order to be converted into depth information. Thus, in such prior art, a processor having higher computation capabilities is demanded in order to satisfy the above operations, resulting in increases in both overall power consumption and system costs. Compared to the above prior art, in some embodiments of the present application, multiple operations for processing time-of-flight sensing data (for example, the sensing data SD) are assigned to and performed by the IPU 126. Thus, computation characteristics of the IPU 126 can be fully applied to process appropriate operations, and the remaining operations may be processed in collaboration with the CPU 124, so as to more efficiently obtain the distance and/or depth information of an object under detection.

To describe related operations performed by the IPU 126, the fundamental concept and operation process of a time-of-flight algorithm are given in brief below. First of all, as previously described, the time-of-flight algorithm measures a distance between the object under detection and the light source module 112 by means of emitting a light signal to the object under detection by the light source module 112. Since the speed of light is constant, the above distance may be expressed as equation (1) below, where d is the distance between the object under detection and the light source module 112, C₀ is the speed of light, and ΔT is a time interval from the light source module 112 that emits the light signal to the sensing module 114 that receives the reflected light signal.

$$d = \frac{1}{2} \times {C}_{0} \times Δ T \qquad ( 1 )$$

However, regarding equation (1) above, it is assumed that the light source module 112 and the sensing module 114 are located at a same position. In actual applications, the light source module 112 and the sensing module 114 have a certain position offset in between. This offset may be corrected by further calibration. Moreover, in some time-of-flight algorithms, if the light source module 112 periodically emits the light signal, a phase shift (equivalent to a time offset) between the light signal emitted by the light source module 112 and the light signal received by the sensing module 114 may be analyzed by means of analyzing image information in the sensing data SD, and this phase shift is converted into the above distance d. For example, the above conversion relationship may be represented as equation (2), where fₘ is the frequency of the light signal emitted by the light source module 112, and φ is the above phase shift.

$$d = \frac{{C}_{0} \times φ}{4 π \times {f}_{m}} \qquad ( 2 )$$

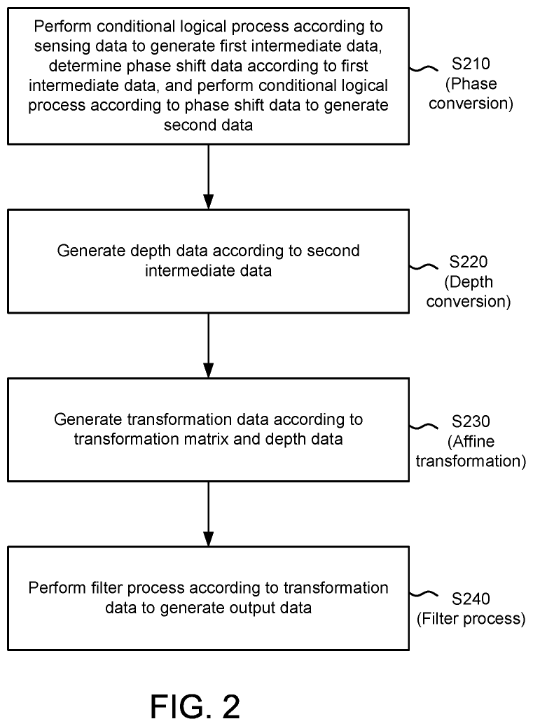

FIG. 2 shows a flowchart of a calculation process of a time-of-flight algorithm executed by the IPU 126 in collaboration with the CPU 124 according to some embodiments of the present application. In some embodiments, the time-of-flight algorithm executed by the IPU 126 in collaboration with the CPU 124 may include a phase conversion (operation S210), a depth conversion (operation S220), an affine transformation (operation S230) and a filter process (operation S240). For better understanding, how to use the IPU 126 to implement the above operations is described in detail below. In some embodiments, mathematical models, functions and/or matrices used in a current time-of-flight algorithm are applied to the above operations, and hence configuration details of these mathematical models, functions and/or matrices are omitted herein.

In operation S210, a conditional logical process is performed according to sensing data (for example, the sensing data SD) to generate first intermediate data, phase shift data (including information of the phase shaft φ) is determined according to the first intermediate data, and the conditional logical process is performed according to the phase shift data to generate second intermediate data.

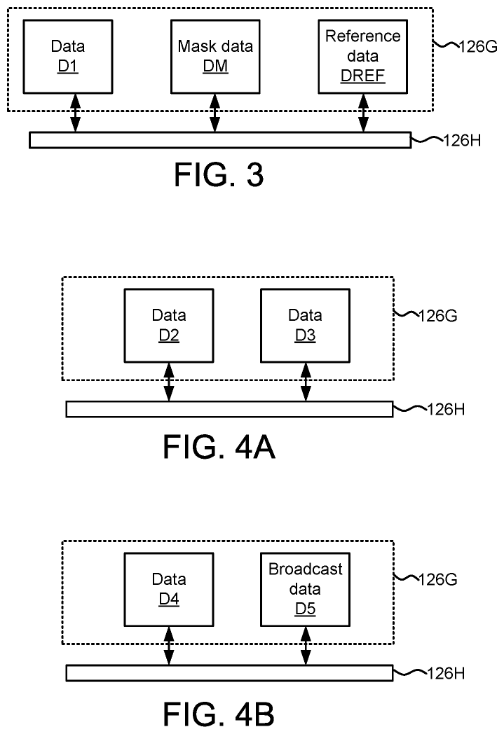

For example, to prevent calculation errors due to information of over-exposure or under-exposure, the IPU 126 may first perform the conditional logical process on the sensing data SD to correct a data value in the sensing data SD to be within a first predetermined range and generate the first intermediate data (that is, the sensing data SD having been corrected). In some embodiments, the above conditional logical process may be performed by the vector data calculating unit 126C in FIG. 1, and associated operation details herein are to be described with reference to FIG. 3 below. If the light signal is expressed mathematically as g^{ref}(t)=cos(2_{π}fₘt), for a given phase shift τᵢ, a related signal g^{corr} may be represented as g^{corr}(t)=g^{ref}(t+τᵢ) . Based the above concept, multiple sets of related image data Ai may be obtained by means of analyzing the first intermediate data, and this may be represented by equation (3) below, where sⁱⁿ(t) is equivalent to image information (that is, the sensing data SD) received by the sensing module 114.

$${A}_{i} = {lim}_{T \to ∞} {\int }_{- \frac{T}{2}}^{\frac{T}{2}} {s}^{i n} ( t ) {g}^{corr} ( t ) dt = {lim}_{T \to ∞} {\int }_{- \frac{T}{2}}^{\frac{T}{2}} {s}^{i n} ( t ) {g}^{ref} ( t + {τ}_{i} ) dt \qquad ( 3 )$$

Thus, during the detection for a reflected light, the sensing module 114 may control the light source module 112 to use light sources at different positions to emit light signals (or control the light source module 112 to use the same light source to emit light signals at different timings), so as to obtain the multiple sets of related image data Aᵢ. For example, the phase shift τᵢ may be 0.5i*π, where i is 0, 1, 2 and 3. Thus, four sets of image data A₀ to A₃ can be obtained, and an image difference between two of the image data A₀ to A₃ can be further obtained (for example, A₃−A₁ and A₀−A₂ in equation (4) below). Under the above conditions, the image differences may be processed by using an arctan2 function to obtain the above phase shift data (including information of the above phase shift φ), wherein the calculation of the arctan2 may be represented by equation (4) below.

φ=arctan2 (A₃−A₁, A₀−A₂) (4)

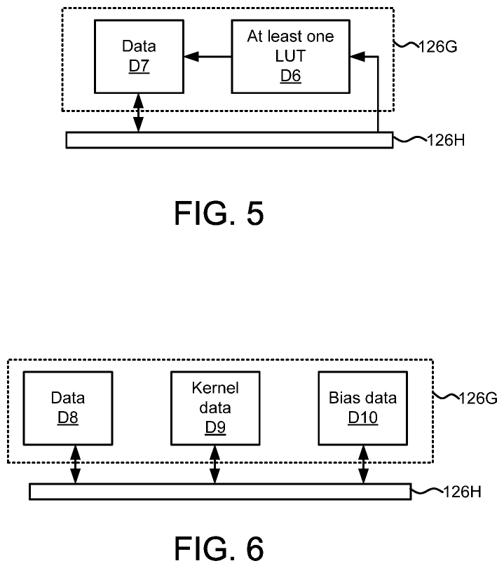

In some embodiments, the image difference between two images is calculated by using pixel values at the same position, and so the image difference may be obtained by means of an element-wise operation performed by the vector data calculating unit 126C in FIG. 1, with associated details herein to be described with reference to FIG. 4A below. In some embodiments, the calculation of the above arctan2 function may be performed by the LUT unit 126D in FIG. 1, with associated details herein to be described with reference to FIG. 5 below. For example, the LUT unit 126D may look up a look-up table according to values of two image differences (for example, A₃3−A₁ and A₀−A₂) to obtain a value of the corresponding distance d. Once the phase shift data is obtained, in order to eliminate an inappropriate phase shift value and ensure validity of data, the data value in the phase shift data may be corrected to be within a predetermined range by performing a conditional logical process on the phase shift data to generate the second intermediate data (that is, corrected phase shift data). Associated details herein are to be described with reference to FIG. 3 below.

In operation S220, depth data is generated according to the second intermediate data. For example, it is known from equation (2) above that the corresponding distance d can be obtained based on the phase shift cp. In some embodiments, the memory 126 in FIG. 1 may have at least one look-up table (for example, at least one LUT D6 in FIG. 5) corresponding to equation (4) and equation (2) stored therein. Thus, the LUT unit 126D may individually perform calculations of equation (4) and equation (2) according to the image differences and the second intermediate data by using the at least one LUT to generate intermediate data (to be referred to as third intermediate data). Next, the vector data calculating unit 126C may perform an element-wise operation on the third intermediate data according to a correction matrix to generate the depth data, with associated details herein to be described with reference to FIG. 4B and FIG. 5 below.

In operation S230, transformation data is generated according to a transformation matrix and the depth data. The calculation in operation S230 is an affine transformation, wherein a data amount of the depth data is adjusted (for example, by means of selecting, level shifting, or scaling) according to the transformation matrix so as to change a resolution of time-of-flight sensing. In some embodiments, the affine transformation is scaling up the depth data to increase the resolution of time-of-flight sensing. In some embodiments, the affine transformation is multiplying the depth data by the transformation matrix to complete the transformation such as level shifting and scaling of images, wherein the transformation matrix may be calculated and obtained by the CPU 124 in FIG. 1. Once the CPU 124 calculates and obtains the transformation matrix, the CPU 124 returns the transformation matrix to the IPU 126. As such, the MAC calculation unit 126F may multiply the depth data by this transformation matrix to generate transformation data (that is, scaled up or scaled down depth data).

In some embodiments, the affine transformation transforms data of each of the coordinates X and Y to x and y by the equation below.

$$[ \begin{matrix}x \\ y\end{matrix} ] = [ \begin{matrix}{a}_{11} & {a}_{12} \\ {a}_{21} & {a}_{22}\end{matrix} ] [ \begin{matrix}X \\ Y\end{matrix} ] + [ \begin{matrix}{b}_{1} \\ {b}_{2}\end{matrix} ]$$

Once transformation matrices [[a11, a12], [a21, a22]] and [b1, b2] are calculated and obtained by the CPU 124, the IPU 126 may complete the above calculation by using the MAC calculation unit 126F according to the above equation.

In some embodiments, the IPU 126 and the CPU 124 have a directly connected transmission path (for example, a transmission path P1 in FIG. 1) in between. Thus, during related operations of the affine transformation, the IPU 126 and the CPU 124 may directly communicate through this transmission path P1 instead of having to communicate through another bus (which is usually further connected to other circuits in the system). For example, to perform operation S230, the CPU 124 may receive a request from the IPU 126 through the transmission path P1 during an interrupt period, calculate the transformation matrix in several following interrupt periods, and return this transformation matrix to the IPU 126 through the transmission path P1 to perform subsequent calculations of operation S230. In some embodiments, the IPU 126 may also be connected to the memory 122 through the transmission path P1 to read required data (including, for example but not limited to, the sensing data SD).

In operation S240, a filter process is performed according to the transformation data to generate output data. With the filter process, influences resulted by unnecessary noise are further reduced. In some embodiments, the output data carries distance, depth and/or profile (that is, edges of the object) of the object under detection. In some embodiments, the filter process may be implemented by the MAC calculation unit 126F in FIG. 1. Associated details herein are to be described with reference to FIG. 6 below. In some embodiments, the DMA controller 126B may store the output data in the memory 122 for the CPU 124 to perform subsequent sensing applications according to the output data.

FIG. 3 shows a schematic diagram of multiple sets of data in the memory 126G in FIG. 1 and used to perform a phase conversion in FIG. 2 according to some embodiments of the present application. In some embodiments, the memory 126G may have data D1, data DREF and mask data DM stored therein. In some embodiments, the vector data calculating unit 126C may perform the conditional logical process in operation S210 (that is, the phase conversion) in FIG. 2 by using the data D1, the data DREF and the mask data DM.

In some embodiments, the mask data DM may be used to store a comparison result between the data D1 and the data DREF. A comparison condition (equivalent to the conditional logical process) used for the comparison result may include, for example but not limited to, greater than, greater than or equal to, smaller than, smaller than or equal to, equal to, and not equal to. As described previously, the vector data calculating unit 126C may perform the conditional logical process on the sensing data SD to correct the data value in the sensing data SD to be within the first predetermined range (for example, between a first value and a second value to be described below), and generate the first intermediate data. For example, assume that data processed by the time-of-flight data processing device 120 is 16-bit, and the sensing data SD is 12-bit. The DMA controller 126B may pad bit 1 to be first four bits of the sensing data SD to correct the sensing data SD to 16-bit data, and store the corrected sensing data SD as the data D1. If the data value of the corresponding pixel (to be referred to as a pixel value below) in the data D1 is smaller than a first value (for example, 0), it is determined that the pixel is under-exposed. Alternatively, if the pixel value is greater than a second value (for example, 1), it is determined that the pixel is over-exposed. Thus, the DMA controller 126B may store the reference data DREF corresponding to the data D1 to the memory 126G, wherein pixel values in the reference data DREF are all in the first value (for example, 0). As such, the vector data calculating unit 126C may obtain the data D1 and the reference data DREF from the memory 126G, and compare the data D1 with the reference data DREF. For example, if the corresponding pixel value in the data D1 is smaller than the corresponding pixel value in the reference data DREF, it means that the pixel value of the data D1 (or the sensing data SD) is smaller than 0. Under the above conditions, the vector data calculating unit 126C may label the corresponding pixel value in the mask data DM as bit 1. Alternatively, if the corresponding pixel value in the data D1 is not smaller than the corresponding pixel value in the reference data DREF, it means that the pixel value of the data D1 (or the sensing data SD) is not smaller than 0. Under the above conditions, the vector data calculating unit 126C may label the corresponding pixel value in the mask data DM as bit 0. In other words, the mask data DM may indicate the comparison result between the data D1 and the data DREF.

Next, the vector data calculating unit 126C may update the data D1 according to the mask data DM. For example, if the corresponding pixel value in the mask data DM is bit 1, the vector data calculating unit 126C may update the corresponding pixel value in the data D1 to bit 0. Alternatively, if the corresponding pixel value in the mask data DM is bit 0, the vector data calculating unit 126C may keep the corresponding pixel value in the data D1 to be in an original value. Thus, the under-exposed pixel value in the data D1 (that is, the sensing data SD) may be corrected to bit 0.

Similarly, the vector data calculating unit 126C may update all of the pixel values of the reference data DREF to a second value (for example, 1), and again compare the updated data D1 with the updated reference data DREF. For example, if the corresponding pixel value in the data D1 is greater than the corresponding pixel value in the reference data DREF, it means that the pixel value of the data D1 is greater than 1. Under the above conditions, the vector data calculating unit 126C may label the corresponding pixel value in the reference data DREF as bit 1. Alternatively, if the corresponding pixel value in the data D1 is not greater than the corresponding pixel value in the reference data DREF, it means that the pixel value of the data D1 is not greater than 1. Under the above conditions, the vector data calculating unit 126C may label the corresponding pixel value in the mask data DM as bit 0. If the corresponding pixel value in the mask data DM is bit 1, the vector data calculating unit 126C may update the corresponding pixel value in the data D1 to bit 1. Alternatively, if the corresponding pixel value in the mask data DM is bit 0, the vector data calculating unit 126C may keep the corresponding pixel value in the data D1 to be in an original value. Thus, the over-exposed pixel value in the data D1 (that is, the sensing data SD) may be corrected to bit 1. Once the above operations are completed, the vector data calculating unit 126C may store the data D1 of the memory 126G as the above first intermediate data.

Next, as described previously, once the phase shift data is obtained, the conditional logical process may be performed on the phase shift data to correct data values in the phase shift data to be within a second predetermined range (for example, between −π and π) and generate the second intermediate data. As described previously, the phase shift data is calculated and obtained by using an arctan2 function, and a numerical range of the arctan2 function ranges between −π and π. Thus, the vector data calculating unit 126C may store the phase shift data as the data D1, and update all the data values in the reference data DREF to be values corresponding to −π. With an operation similar to the above, any data value lower than −π in the data D1 (that is, the phase shift data) can be corrected. Next, the vector data calculating unit 126C may update all the data values in the reference data DREF to be values corresponding to π. With the same operation, any data value higher than πin the data D1 (that is, the phase shift data) can be corrected. Once the above operations are completed, the vector data calculating unit 126C may store the data D1 of the memory 126G as the above second intermediate data. With the above operations, the data validity of the phase shift data is ensured to enhance the accuracy of subsequent calculations.

FIG. 4A shows a schematic diagram of multiple sets of data in the memory in FIG. 1 and used to perform a phase conversion in FIG. 2 according to some embodiments of the present application. In some embodiments, the memory 126G may store data D2 and data D3, which may be used to perform the element-wise operation used in operation S210 in FIG. 2. As described previously, before the arctan2 function of equation (4) is executed, a value of the difference between two sets of image data (for example, A₃−A₁ and A₀−A₂) may be calculated by an element-wise operation. Because the image data A₀ to A₃ have the same data format and dimensional format (that is, having the same number of data values (or referred to as element values)), the DMA controller 126B may store the first intermediate data (that is, the sensing data SD corrected to be within the first predetermined range) obtained at different timings to the memory 126G as the data D2 and the data D3, and the vector data calculating unit 126C may perform the element-wise operation (in this example, subtraction) according to the data D2 and the data D3 to obtain the above image difference.

For example, assume that the image data A₀ to A₃ sequentially corresponds to the first intermediate data at a first timing, a second timing, a third timing and a fourth timing, the DMA controller 126B may store the first intermediate data (equivalent to the image data A₀) corresponding to the first timing as the data D2, and store the first intermediate data (equivalent to the image data A₂) corresponding to the third timing as the data D3. Thus, the vector data calculating unit 126C may perform the element-wise operation according to the data D2 and the data D3 to subtract the corresponding pixel value in the data D3 from the corresponding pixel value in the data D2, so as to calculate the image difference A₀−A₂. With a similar operation, the vector data calculating unit 126C may calculate the image difference A₃−A₁.

FIG. 4B shows a schematic diagram of multiple sets of data in a memory in FIG. 1 and used to perform a depth conversion in FIG. 2 according to some embodiments of the present application. In some embodiments, the memory 126G may store data D4 and broadcast data D5, which may be used to perform the element-wise operation used in operation S220 in FIG. 2.

As described previously, before the arctan2 function of equation (4) is executed, the vector data calculating unit 126C may perform an element-wise operation on the third intermediate data according to a correction matrix to generate the depth data. In this example, the element-wise operation is a dot product operation (or referred to as an inner product operation). Because the depth data and the correction matrix have different dimensional formats (that is, the numbers of data values of the two are different), the vector data calculating unit 126C may determine according to data values of the data D4 and the broadcast data D5 that the two are different, and use a broadcast operation to complete the operation. For example, the DMA controller 126B may store the intermediate data to the memory 126G as the data D4 and store the correction matrix to the memory 126G as the broadcast data D5. The vector data calculating unit 126C may determine according to the data D4 and the broadcast data D5 that the two have different dimensional formats; for example, the dimension of the data D4 is (1, 224, 224, 3) and the dimension of the broadcast data D5 is (1, 1, 1, 3). In the above conditions, the vector data calculating unit 126C may perform one round of dot product operation on three data values in the data D4 and one data value in the broadcast data D5, and perform 224*224 rounds of dot product operation to generate the depth data. In other words, if the dimensions of two sets of data to undergo the element-wise operation are different, the vector data calculating unit 126C may complete the overall operation on the data values of the two by means of repeatedly using multiple rounds of the dot product operation.

In some related art, if a universal processor is used to perform a dot product operation of data having different dimensions, the data value in the low-dimensional data is duplicated into multiple duplicates to expand the number of data values in the low-dimensional to be equal to the number of data values in the high-dimensional data. Thus, the universal processor is enabled to sequentially fetch these data values from the memory to perform the dot product operation one after another. In the above art, larger memory spaces and/or bandwidths are needed, and the universal processor also consumes more time to access the memory in order to obtain the data values during the operations. Compared to the above art, the IPU 126 may use characteristics of a broadcast operation (that is, repeating multiple rounds of operation) instead of expanding data values to perform the above operation, hence more efficiently perform the element-wise operation herein.

In different embodiments, the element-wise operations in FIG. 4A and FIG. 4B may be used to implement, for example but not limited to, addition, subtraction, multiplication and division calculations. Based on the similar configuration, the vector data calculating unit 126C may perform such as trace, inverse and transpose operations. According to different time-of-flight algorithms, the IPU 126 may also perform data processing by selectively using the above operations.

FIG. 5 shows a schematic diagram of multiple sets of data in the memory 126G in FIG. 2 and used to perform a phase conversion and a non-linear function in a depth conversion in FIG. 2 according to some embodiments of the present application. In some embodiments, the memory 126G may store a look-up table (LUT) D6 and data D7, which may be used to perform part of the operation (for example, equation (2) and equation (4)) used in operations S210 and S220 in FIG. 2. In some embodiments, the LUT D6 may include an LUT corresponding to equation (2) and an LUT corresponding to equation (4).

In some embodiments, the memory 126G may store calculation results of equation (2) and equation (4). For example, the arctan2 function of equation (4) may be decomposed into one or more calculations by using an interpolation function, and the calculation results of the one or more calculations can be stored as a part of the data of the LUT D6. Similarly, the calculation result of equation (2) may be stored as another part of data of the LUT D6. In some embodiments, the LUT D6 may include an LUT corresponding to equation (2) and an LUT corresponding to equation (4). The LUT unit 126D may look up the LUT corresponding to equation (4) from the LUT D6 according to the above multiple image differences to obtain phase shift data (for example, the value of the phase shift φ in equation (4)), and look up the LUT corresponding to equation (2) from the LUT D6 according to the second intermediate data (that is, the corrected phase shift data) to obtain corresponding depth information (for example, the value of the distance d in equation (2)). The LUT unit 126D may store the corresponding depth information to the memory 126G, as data D7 (equivalent to the above third intermediate data). Thus, the vector data calculating unit 126C may perform an element-wise operation on the third intermediate data according to a correction matrix to generate the depth data.

With the above configuration, the IPU 126 is enabled to execute the non-linear function and achieve a certain operation accuracy. The overall operation process can be simplified by means of decomposing a non-linear function by using an LUT. Thus, compared to directly performing a non-linear operation by a universal processor, operation efficiency can be more significantly enhanced.

FIG. 6 shows a schematic diagram of multiple sets of data in the memory 126G in FIG. 2 and used to perform a filter process in FIG. 2 according to some embodiments of the present application. In some embodiments, the memory 126G may store data D8, kernel data D9 and bias data D10, which may be used to perform operation S240 in FIG. 2.

For example, in operation S230, the MAC calculation unit 126F stores transformation data to the memory 126G, as the data D8. Next, the MAC calculation unit 126F may read the data D8, the kernel data D9 and the bias data D10 from the memory 126G to perform a convolution operation (equivalent to the filter process), and output an operation result as the output data DO. In some embodiments, the kernel data D9 is used to define a filter mask in image filtering, and the bias data D10 is used to define a moving distance of the filter mask on the data D8. The above filter process conforms to characteristics of a multiply-accumulate calculation originally set by the MAC calculation unit 126F, and so a processing speed of the filter process can be accelerated by using the MAC calculation unit 126F.

In some embodiments, a single-instruction multiple-data (SIMD) technique may be used in coordination in the above multiple operations to further enhance the execution efficiency. In some embodiments, a universal program language, for example but not limited to, Python, may be used to establish a software interface, allowing a user to provide data through this interface for the IPU 126 to develop a model and a design for the time-of-flight algorithm.

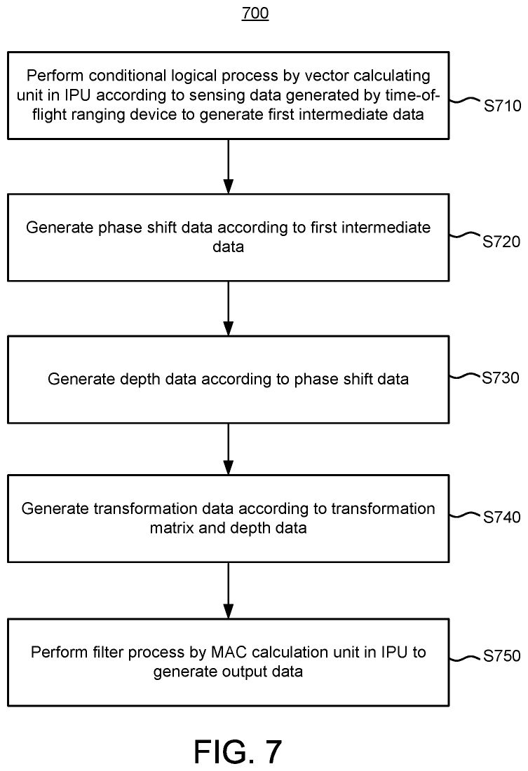

FIG. 7 shows a flowchart of a data processing method 700 according to some embodiments of the present application. In some embodiments, the data processing method 700 may be performed by, for example but not limited to, the time-of-flight data processing device 120 in FIG. 1.

In operation S710, a conditional logical process is performed by a vector calculating unit in an intelligence processing unit (IPU) according to sensing data generated by a time-of-flight ranging device to generate first intermediate data. In operation S720, phase shift data is generated according to a first intermediate data. In operation S730, depth data is generated according to the phase shift data. In operation S740, transformation data is generated according to a transformation matrix and the depth data. In operation S750, a filter process is performed by a multiply-accumulate (MAC) calculation unit in the IPU according to the transformation data to generate output data.

The details of the plurality of operations above may be referred from the description associated with the foregoing embodiments, and are omitted herein for brevity. The plurality operations of the data processing method 700 above are merely examples, and are not limited to being performed in the order specified in this example. Without departing from the operation means and ranges of the various embodiments of the present application, additions, replacements, substitutions or omissions may be made to the operations of the data processing method 700, or the operations may be performed in different orders (for example, simultaneously performed or partially simultaneously performed).

In conclusion, the time-of-flight data processing device and the data processing method thereof according to some embodiments of the present application are capable of processing time-of-flight data by using operation characteristics of an IPU, so as to accelerate the operation efficiency of processing the time-of-flight data.

While the present application has been described by way of example and in terms of the preferred embodiments, it is to be understood that the disclosure is not limited thereto. Various modifications made be made to the technical features of the disclosure by a person skilled in the art on the basis of the explicit or implicit disclosures of the present application. The scope of the appended claims of the present application therefore should be accorded with the broadest interpretation so as to encompass all such modifications.

What is claimed is:

1. A time-of-flight data processing device, comprising:
an intelligence processing unit (IPU), performing following operations on sensing data generated by a time-of-flight ranging device:
performing a conditional logical process and an image difference calculation according to the sensing data to generate depth data; and
performing a filter process according to the depth data to generate output data,
wherein, the IPU comprises a vector calculating unit and a multiply-accumulate (MAC) calculation unit, the conditional logical process is performed by the vector calculating unit, and the filter process is performed by the (MAC) calculation unit.

2. The time-of-flight data processing device according to claim 1, wherein the vector calculating unit performs the conditional logical process according to the sensing data to correct a data value of the sensing data to be within a first predetermined range.

3. The time-of-flight data processing device according to claim 1, wherein the IPU comprises:
a look-up table (LUT) unit, looking up an LUT according to a plurality of image differences generated by the image difference calculation to generate phase shift data.

4. The time-of-flight data processing device according to claim 3, wherein the vector calculating unit further corrects the phase shift data to correct a data value of the phase shift data to be within a second predetermined range, and the LUT unit looks up another LUT according to the corrected phase shift data to generate the depth data.

5. The time-of-flight data processing device according to claim 4, wherein the vector calculating unit performs a dot product operation according to a result of looking up the another LUT and a correction matrix to generate the depth data.

6. The time-of-flight data processing device according to claim 3, wherein the LUT comprises a calculation result of an artan2 function.

7. The time-of-flight data processing device according to claim 1, further comprising:
a central processing unit (CPU), configured to calculate a transformation matrix;
wherein, the MAC calculation unit further performs an affine transformation according to the transformation matrix and the depth information to adjust a resolution corresponding to the depth data.

8. The time-of-flight data processing device according to claim 7, wherein the IPU directly communicates with the CPU through a connection path so as to receive the transformation matrix.

9. A data processing method, comprising:
performing a conditional logical process and an image difference calculation, by a vector calculating unit in an intelligence processing unit (IPU), according to sensing data generated by a time-of-flight ranging device to generate depth data; and
performing a filter process, by a multiply-accumulate (MAC) calculation unit in the IPU, according to the depth data to generate output data.

10. The data processing method according to claim 9, wherein the vector calculating unit performs the conditional logical process according to the sensing data to correct a data value of the sensing data to be within a first predetermined range.

11. The data processing method according to claim 9, further comprising:
looking up a look-up table (LUT) by an LUT unit in the IPU according to a plurality of image differences generated by the image difference calculation to generate phase shift data.

12. The data processing method according to claim 11, wherein the vector calculating unit further corrects the phase shift data to correct a data value of the phase shift data to be within a second predetermined range, and the LUT unit looks up another LUT according to the corrected phase shift data to generate the depth data.

13. The data processing method according to claim 12, wherein the vector calculating unit performs a dot product operation according to a result of looking up the another LUT and a correction matrix to generate the depth data.

14. The data processing method according to claim 11, wherein the LUT comprises a calculation result of an artan2 function.

15. The data processing method according to claim 9, further comprising:
calculating a transformation matrix by a central processing unit (CPU);
wherein, the MAC calculation unit further performs an affine transformation according to the transformation matrix and the depth information to adjust a resolution corresponding to the depth data.
